(19) United States
(12) Patent Application Publication
(10) Pub. No.: US 2008/0039359 A1
(43) Pub. Date: Feb. 14, 2008

(54) Cleanser for Slit Coater, Slit Coater for Manufacturing Display Device and Manufacturing Method for Display Device

(76) Inventors: Gug-rae Jo, Cheonan-si (KR); Byoung-joo Kim, Anyang-si (KR); Yi-seop Shim, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/674,390

(22) Filed: Feb. 13, 2007

(30) Foreign Application Priority Data
Feb. 13, 2006 (KR) 10-2006-0013590

(51) Int. Cl. C11D 1/72

(52) U.S. Cl. 510/506

(57) ABSTRACT

Disclosed are a cleanser for a slit coater, a slit coater for manufacturing a display device and a manufacturing method for a display device. The cleanser for the slit coater comprises propylene glycol mono-methyl ether in an amount of about 70 to about 90 wt %, propylene glycol mono-methyl ether acetate in an amount of about 5 to about 20 wt %, and ethyl(3-ethoxy)propionate in an amount of about 5 to about 20 wt %.

### CROSS-REFERENCE TO RELATED APPLICATIONS

This application claims the benefit of Korean Patent Application No. 2006-0013590, filed on Feb. 13, 2006, the disclosure of which is hereby incorporated by reference herein in its entirety.

### BACKGROUND OF THE INVENTION

1. Technical Field

The present disclosure relates to a cleanser for a slit coater, a slit coater for manufacturing a display device and a manufacturing method for a display device.

2. Description of the Related Art

There has been an increasing demand for flat panel display devices such as, for example, LCD (liquid crystal display) devices, POP (plasma display panel) devices, and OLED (organic light emitting diode) devices.

Typically, when manufacturing such flat panel display devices, a coating layer is formed on a substrate. The coating layer is patterned through, for example, exposure and development.

The coating layer may be formed through spin coating or slit coating. With a slit coating method, a slit coater which has a slim nozzle discharges coating liquid on the substrate through the nozzle while moving over the substrate.

Moreover, a cleanser is used to cleanse the slit coater, when necessary. For example, when color filters of an LCD device are formed using color photosensitive liquids of different colors, the slit coater may need to be cleansed before replacing the color photosensitive liquid with a new one.

However, the nozzle of the slit coater is typically so narrow that the slit coater may not be cleansed efficiently.

### SUMMARY OF THE INVENTION

Accordingly, exemplary embodiments of the present invention provide a cleanser for a slit coater which efficiently cleanses a slit coater.

Exemplary embodiments of the present invention provide a slit coater with efficient cleansing capability for manufacturing a display device.

Exemplary embodiments of the present invention provide a manufacturing method of a display device which efficiently cleanses a slit coater.

In accordance with an exemplary embodiment of the present invention, a cleanser for a slit coater is provided. The cleanser includes propylene glycol mono-methyl ether in an amount of about 70 to about 90 wt %, propylene glycol mono-methyl ether acetate in an amount of about 5 to about 20 wt %, and ethyl(3-ethoxy) propionate in an amount of about 5 to about 20 wt %.

For example, the amount of propylene glycol mono-methyl ether is about 75 to about 85 wt %, the amount of propylene glycol mono-methyl ether acetate is about 7 to about 13 wt %, and the amount of ethyl(3-ethoxy)proplyonate is about 7 to about 13 wt %.

For example, the cleanser further includes acetone in an amount of about 5 to about 10 wt %.

In accordance with an exemplary embodiment of the present invention, a cleanser for a slit coater is provided. The cleanser includes propylene glycol mono-methyl ether acetate in an amount of about 80 to about 97 wt % and acetone in an amount of about 3 to about 20 wt %.

For example, the amount of propylene glycol mono-methyl ether acetate is about 90 to about 95 wt %, and the amount of acetone is about 5 to about 10 wt %.

For example, the cleanser further includes propylene glycol mono-methyl ether in an amount of about 5 to about 15 wt %.

For example, the cleanser further includes ethyl(3-ethoxy)propionate in an amount of about 5 to about 15 wt %.

In accordance with an exemplary embodiment of the present invention a slit coater for manufacturing a display device is provided. The slit coater includes a slit nozzle, a color photosensitive liquid supplier which supplies at least two color photosensitive liquids of different colors to the slit nozzle and a cleanser supplier which supplies the slit nozzle with a cleanser for a slit coater. The cleanser includes propylene glycol mono-methyl ether in an amount of about 70 to about 90 wt %, propylene glycol mono-methyl ether acetate in an amount of about 5 to about 20 wt %, and ethyl(3-ethoxy)propionate in an amount of about 5 to about 20 wt %.

For example, the cleanser for the slit coater includes propylene glycol mono-methyl ether in an amount of about 75 to about 85 wt %, propylene mono-methyl ether acetate in an amount of 7 to 13 wt %, and ethyl(3-ethoxy)propionate in an amount of about 7 to about 13 wt %.

For example, the cleanser for the slit coater further includes acetone in the amount of about 5 to about 10 wt %.

In accordance with an exemplary embodiment of the present invention a slit coater for manufacturing a display device is provided. The slit coater includes a slit nozzle, a color photosensitive liquid supplier which supplies at least two color photosensitive liquids of different colors to the slit nozzle and a cleanser supplier which supplies the slit nozzle with a cleanser for a slit coater. The cleanser includes propylene glycol mono-methyl ether acetate in an amount of about 80 to about 97 wt %, and acetone in an amount of about 3 to about 20 wt %.

For example, the cleanser for the slit coater includes propylene glycol mono-methyl ether acetate in an amount of about 90 to about 95 wt %, and acetone in an amount of about 5 to about 10 wt %.

For example, the cleanser for the slit coater further includes propylene glycol mono-methyl ether in an amount of about 5 to about 15 wt %.

For example, the cleanser for the slit coater further includes ethyl(3-ethoxy)propionate in an amount of about 5 to about 15 wt %.

In accordance with an exemplary embodiment of the present invention a method of manufacturing a display device is provided. The method includes forming a first color photosensitive layer by coating a substrate with a first color photosensitive liquid through a slit nozzle, forming a first sub color filter by patterning the first color photosensitive layer and cleansing the slit nozzle by supplying a slit coater cleanser to the slit nozzle. The cleanser includes propylene glycol mono-methyl ether in an amount of about 70 to about 90 wt %, propylene glycol mono-methyl ether acetate in an amount of about 5 to about 20 wt %, and ethyl (3-ethoxy) propionate in an amount of about 5 to about 20 wt %. The method further includes forming a second color photosensitive layer by coating the first sub color filter with a second color photosensitive liquid through the slit nozzle.

For example, the cleanser for the slit coater includes propylene glycol mono-methyl ether in an amount of about 75 to about 85 wt %, propylene glycol mono-methyl ether acetate in an amount of about 7 to about 13 wt % and ethyl (3-ethoxy)propionate in an amount of about 7 to about 13 wt %.

For example, the cleanser for the slit coater further includes acetone in an amount of about 5 to about 10 wt %.

In accordance with an exemplary embodiment of the present invention a method of manufacturing a display device is provided. The method includes forming a first color photosensitive layer by coating a substrate with a first color photosensitive liquid through a slit nozzle, forming a first sub color filter by patterning the first color photosensitive layer and cleansing the slit nozzle by supplying a slit coater cleanser to the slit nozzle. The cleanser includes propylene glycol mono-methyl ether acetate in an amount of about 80 to about 97 wt % and acetone in an amount of about 3 to about 20 wt %. The method further includes forming a second color photosensitive layer by coating the first sub color filter with a second color photosensitive liquid through the slit nozzle.

For example, the cleanser for the slit coater includes propylene glycol mono-methyl ether acetate in amount of about 90 to about 95 wt % and acetone in an amount of about 5 to about 10 wt %.

For example, the cleanser for the slit coater further includes propylene glycol mono-methyl ether in an amount of about 5 to about 15 wt %.

For example, the cleanser for the slit coater further includes ethyl(3-ethoxy)propionate in an amount of about 5 to about 15 wt %.

### BRIEF DESCRIPTION OF THE DRAWINGS

Exemplary embodiments of the present invention can be understood in more detail from the following description taken in conjunction with the accompany drawings in which:

FIG. 1 is a block diagram of a slit coater according to an exemplary embodiment of the present invention;

FIG. 2 is a perspective view of a slit nozzle of the slit coater according to an exemplary embodiment of the present invention;

FIG. 3 is a sectional view taken along line III-III in FIG. 2;

FIG. 4 is a sectional view taken along line IV-IV in FIG. 2;

FIGS. 5 and 6 illustrate a test result according to the present invention;

FIG. 7 illustrates a display device which is manufactured by using the slit coater according to an exemplary embodiment of the present invention;

FIG. 8 is a flowchart illustrating a method of manufacturing the display device according to an exemplary embodiment of the present invention; and

FIGS. 9a through 9g illustrate a manufacturing method of the display device according to an exemplary embodiment of the present invention.

### DETAILED DESCRIPTION OF THE EXEMPLARY EMBODIMENTS

Hereinafter, exemplary embodiments of the present invention will be described with reference to accompanying drawings, wherein like numerals refer to like elements and repetitive descriptions will be avoided as necessary.

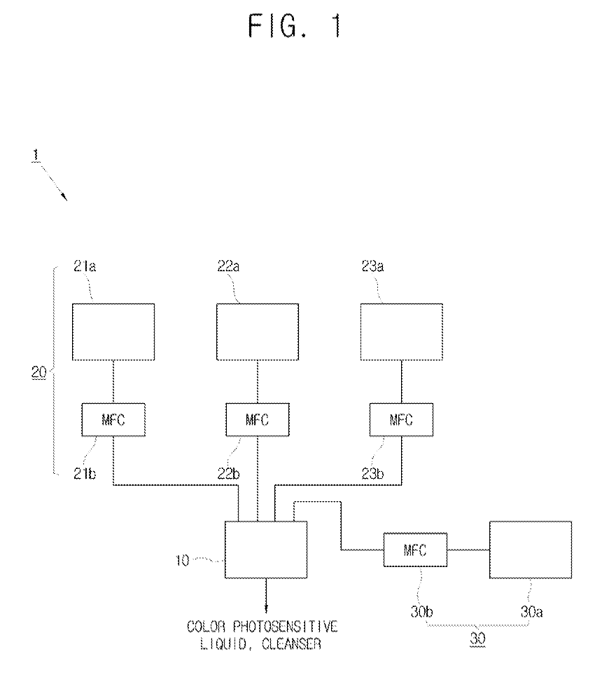

A slit coater according to an exemplary embodiment of the present invention will be described with reference to FIG. 1.

Referring to FIG. 1, a slit coater 1 comprises a slit nozzle 10, a color photosensitive liquid supplier 20 and a cleanser supplier 30. The slit coater 1 may further comprise a driver which allows the slit nozzle 10 to move on a plane.

The slit nozzle 10 is supplied with color photosensitive liquid from the color photosensitive liquid supplier 20 and discharges the supplied color photosensitive liquid on a substrate. The slit nozzle 10 will be described in further detail later herein.

The color photosensitive liquid supplier 20 comprises three color photosensitive liquid tanks 21a, 22a and 23a and mass flow controllers 21b, 22b and 23b which are connected to the color photosensitive liquid tanks 21a, 22a and 23a, respectively. The color photosensitive liquid tanks 21a, 22a and 23a store the color photosensitive liquid of different colors, such as for example, blue, green and red photosensitive liquid, respectively.

The cleanser supplier 30 comprises a cleanser tank 30a and a mass flow controller 30b which is connected to the cleanser tank 30a.

The color photosensitive liquid supplier 20 and the cleanser supplier 30 supply the color photosensitive liquid and the cleanser, respectively, to the slit nozzle 10. The slit nozzle 10 discharges the color photosensitive liquid on the substrate or the interior of the slit nozzle 10 is cleansed by the cleanser.

In this exemplary embodiment, the cleanser supplier 30 supplies a first cleanser or a second cleanser. The first cleanser comprises propylene glycol mono-methyl ether acetate (PGMEA) in an amount of about 5 to about 20 wt %, propylene glycol mono-methyl ether (PGME) in an amount of about 70 to about 90 wt %, and ethyl(3-ethoxy)propionate (ESP) in an amount of about 5 to about 20 wt %. For example, the first cleanser may comprise PGMEA in an amount of about 7 to about 13 wt %, PGME in amount of about 75 to about 85 wt % and EEP in an amount of about 7 to about 13 wt %.

The specific gravity of PGMEA is about 0.968 at about 25° C., and the viscosity thereof is about 1.3 cps. The boiling point of PGMEA is about 145 to about 146° C. at atmospheric pressure, and the flash point thereof is about 42° C. When PGMEA is smaller than about 5 wt % or larger than about 20 wt %, the solubility of the first cleanser is affected. When EEP is smaller than about 5 wt % or larger than about 20 wt %, the solubility of the first cleanser is affected, too. As SEP is more expensive than PGMEA or PGME, the more SEP used, the higher the production cost for the first cleanser will be.

The first cleanser may further comprise acetone in an amount of about 5 to about 10 wt %.

The second cleanser comprises PGMEA in an amount of about 80 to about 97 wt % and acetone in an amount of about 3 to about 20 wt %. For example, the second cleanser may comprise PGMEA in an amount of about 90 to about 95 wt % and acetone in an amount of about 5 to about 10 wt %.

When acetone is less than about 3 wt %, the cleansing capability is not as effective. The cleansing capability of the second cleanser increases with an increase in the content of acetone. However, when the content or amount of acetone is more than about 20 wt %, the flash point is reduced to about −1° C., thereby possibly leading to dangerous processing conditions.

Table 1 shows flash points of the second cleanser depending on the content of acetone. The rest of the content of the second cleanser except the content of acetone is PGMEA.

TABLE 1

| Content of acetone | |
|---|---|
| (wt %) | Flash point (° C.) |
| 5 | 19 |
| 10 | 10 |
| 20 | −1 |
| 30 | −7 |

The second cleanser may further comprise PGMEA in an amount of about 5 to about 10 wt % and/or EEP in an amount of about 5 to about 15 wt %.

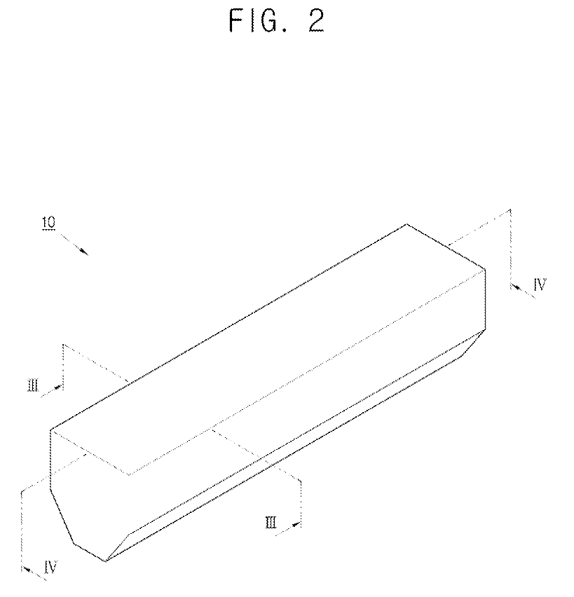

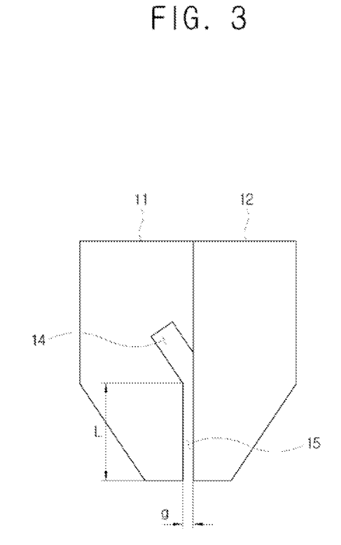

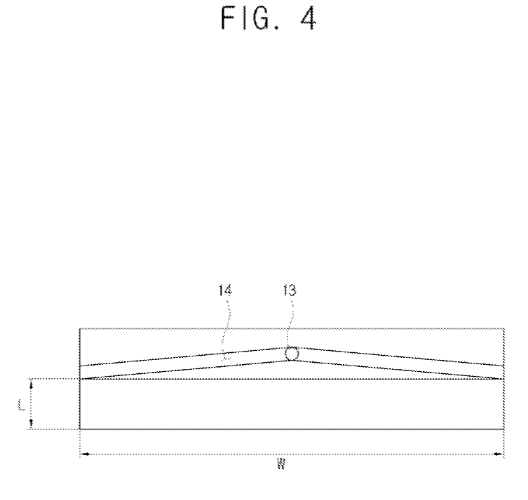

Referring to FIGS. 2 to 4, the slit nozzle 10 is elongated and is supplied with the color photosensitive liquid and the cleanser from the color photosensitive supplier 20 and the cleanser supplier 30, respectively. The width (W) of the slit nozzle 10 may vary depending on the size of a substrate to be coated. For example, the width (W) may be approximately 800 mm to 2000 mm.

The slit nozzle 10 comprises a first sub main body 11 and a second sub main body 12 which are adhered to each other. The first sub main body 11 is more complex than the second sub main body 12. The first sub main body 11 comprises an injector 13, a cavity 14 and a nozzle part 15.

The injector 13 is connected to the color photosensitive liquid supplier 20 and the cleanser supplier 30 and is supplied with the color photosensitive liquid or the cleanser therefrom. The injector 13 is disposed on about the center of the slit nozzle 10 in a lengthwise direction.

The cavity 14 is connected to the injector 13 and elongated to opposite sides of the injector 13. Both sides of the cavity 14 are symmetrical with respect to the injector 13.

The color photosensitive liquid or the cleanser supplied to the injector 13 is supplied to the nozzle part 15 through the cavity 14. The greater the distance the cavity 14 is from the injector 13, the lower the cavity 14 is. An inclination angle, e.g., a hanger angle θ, of the cavity 14 may be around 1°.

The first sub main body 11 and the second sub main body 12 face each other, with a small gap (g) therebetween, and form the nozzle part 15. The nozzle part 15 is connected to the cavity 14, and a gap (g) of the nozzle part 15 may be about 60 μm to about 140 μm.

The orifice length (L) of the nozzle part 15 varies depending on the position of the cavity 14. That is, the orifice length (L) of the nozzle part 15 is longest in the center of the slit nozzle 10 where the cavity 14 is located on the top, and is shortest in both ends of the slit nozzle 10 where the cavity 14 is located on the bottom.

Hereinafter, the first cleanser and second cleanser will be described with reference to a test result.

The test is aimed to examine how much a blue color filter formed on a substrate is removed with time while being applied with the cleanser.

The blue color filter is prepared, for example, by dropping a blue photosensitive liquid (YB755™ available from DongWoo Fine Chem in R.O.K.) on the substrate through a syringe and by drying the substrate. The solid matter content of the blue photosensitive liquid is about 12 wt % and a solvent comprises a mixture of PGMEA and EEP with a ratio of about 6:4.

The cleanser is supplied to the blue color filter at a flow of about 1.3 ml/min by means of a metering pump. To minimize an error according to a drying state of the blue color filter, the blue photosensitive liquid is dropped on the blue color filter of the same substrate, simultaneously.

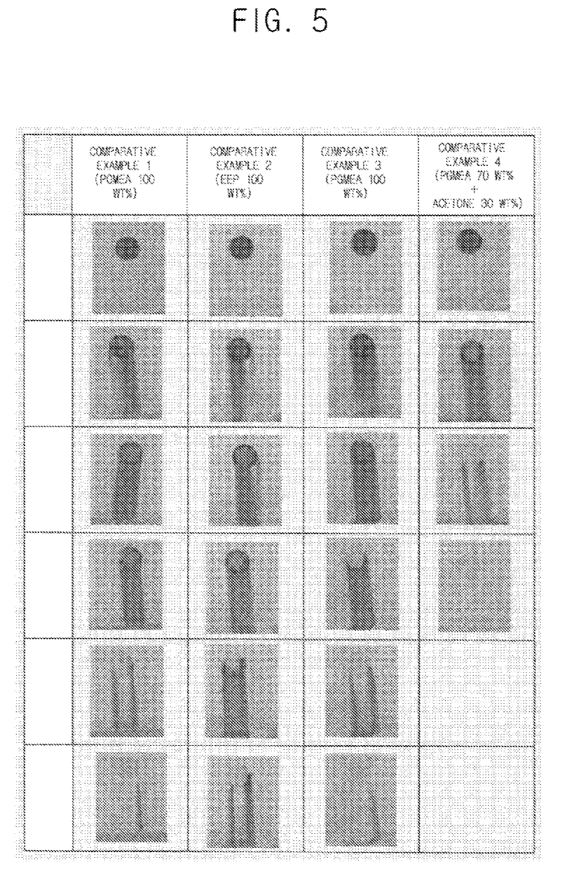

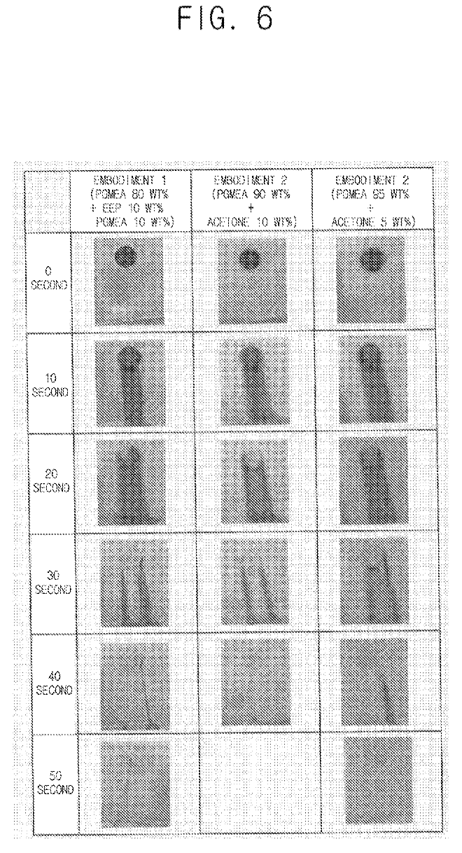

FIG. 5 shows results of comparative examples 1 to 4. FIG. 6 shows results of exemplary embodiments 1 to 3.

Referring to FIG. 5, in the comparative examples 1 to 3 in which PGMEA, PGMS and EEP are solely used, respectively, the blue color filter remains a little after about 50 seconds. On the other hand, in the comparative example 4 where PGMEA in an amount of about 70 wt % and acetone in an amount of about 30 wt % are used, most of the blue color filter is removed after about 30 seconds. However, the comparative example 4 shows sufficient cleansing capability, but has an unacceptable flash point of about −7° C.

Referring to FIG. 6, in exemplary embodiment 1 where PGME in an amount of about 80 wt %, EEP in an amount of about 10 wt % and PGMEA in an amount of about 10 wt % are used, most of the blue color filter is removed after about 50 seconds. In exemplary embodiment 2 where PGMEA in an amount of about 90 wt % and acetone in an amount of about 10 wt % are used, most of the blue color filter is removed after about 40 seconds. In exemplary embodiment 3 where PGMEA in an amount of about 90 wt % and acetone in an amount of about 5 wt % are used, most of the blue color filter is removed after about 50 seconds.

From the test result, it may be concluded that exemplary embodiments 1 to 3 provide lisp roved cleansing capability for the blue color filter in comparison to the comparative examples 1 to 3.

The foregoing result may be true of red and green color filters.

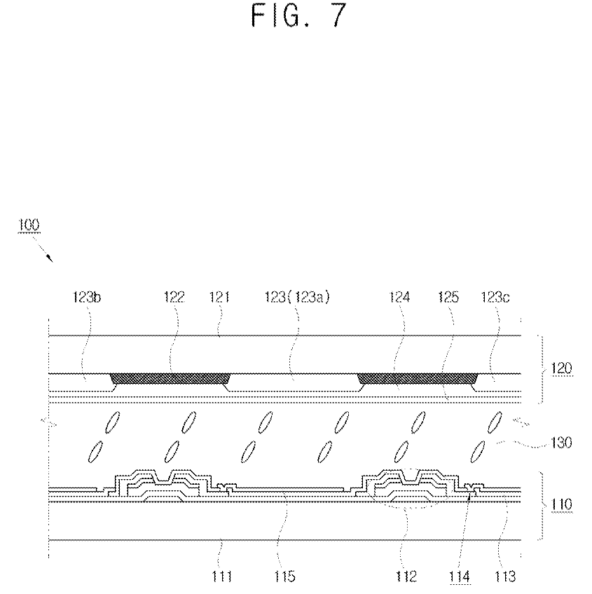

Hereinafter, a display device which is manufactured by using the slit coater according to an exemplary embodiment of the present invention will be described with reference to FIG. 7.

A liquid crystal display (LCD) device 100, which is manufactured according to an exemplary embodiment of the present invention, comprises a thin film transistor substrate 110, a color filter substrate 120, and a liquid crystal layer 130 which is interposed between the thin film transistor substrate 110 and the color filter substrate 120.

The thin film transistor substrate 110 comprises an insulating substrate 111, and a plurality of thin film transistors 112 which is formed on the insulating substrate 111. A passivation layer 113 covers the thin film transistors 112. A portion of the passivation layer 113 is removed to form a contact hole 114 through which the thin film transistor 112 is exposed. A pixel electrode 115 made of a transparent conductive material is connected to the thin film transistor 112 through the contact hole 114.

The color filter substrate 120 comprises an insulating substrate 121 and grid-shaped black matrixes 122 formed on the insulating substrate 121. The black matrix 122 may be made of, for example, an organic material containing a black pigment. The black matrix 122 is formed to correspond to the thin film transistor 112 and a wire of the thin film transistor substrate 122.

A color filter 123 is formed between, for example, the black matrixes 122. The color filter 123 is made of an organic material and comprises three sub layers 123a, 123b and 123c which have different colors. An overcoat layer 124 and a common electrode 125, which is made of, for example, a transparent conductive material, are formed on the black matrixes 122 and the color filter layer 123.

An electric field produced by the pixel electrode 115 and the common electrode 125 determines the alignment of liquid crystals in the liquid crystal layer 130 which is disposed between the thin film transistor substrate 110 and the color filter substrate 120. The transmittivity of light, which is supplied from a lower part of the thin film transistor substrate 110, is adjusted by the liquid crystal layer 130. Then, the light has a color while passing through the color filter layer 123 and a polarizing plate attached to an external surface of the color filter substrate 120.

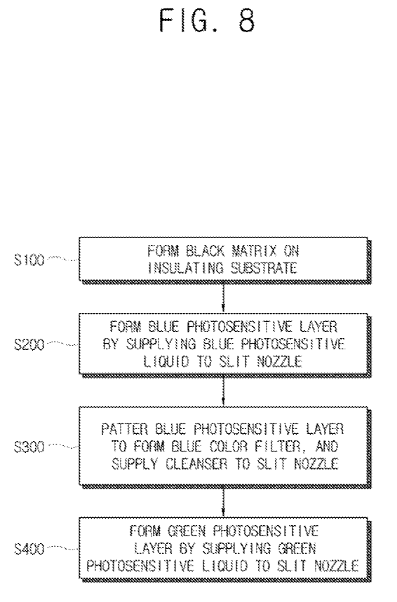

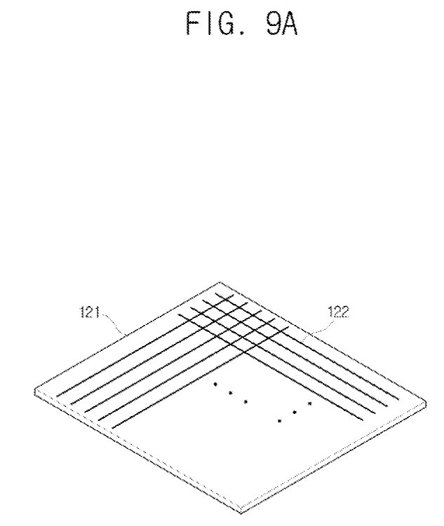

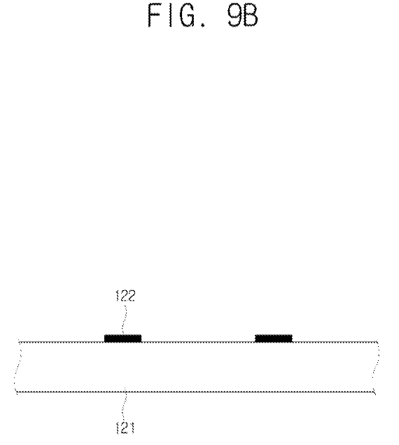

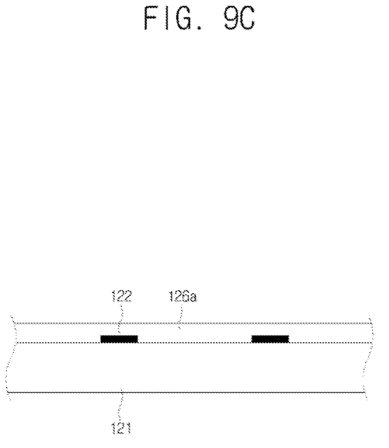

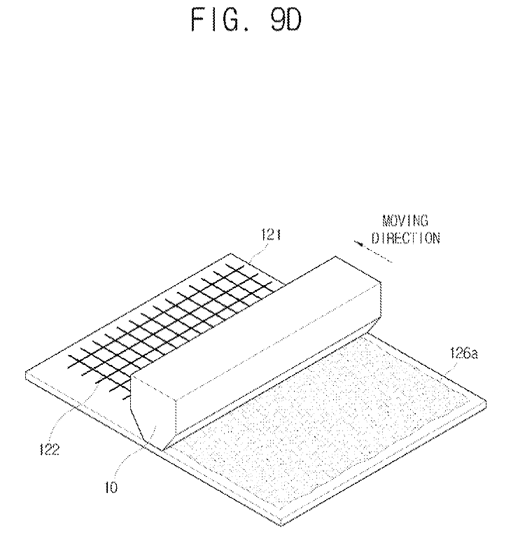

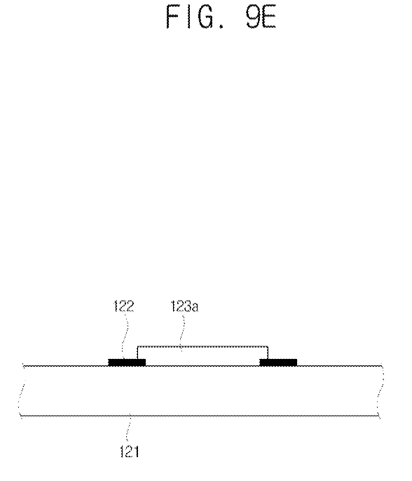

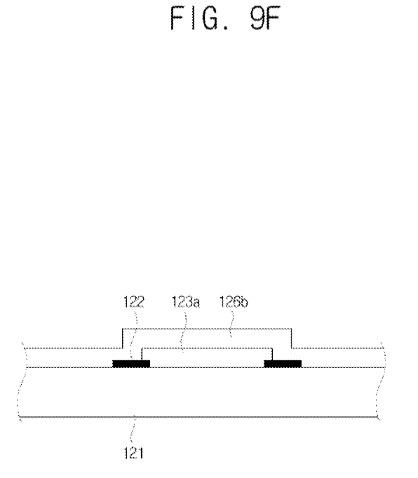

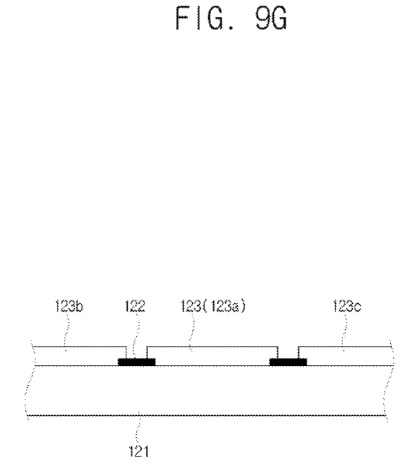

Hereinafter, a manufacturing method of the display device according to an exemplary embodiment of the present invention will be described with reference to FIGS. 8 through 9g.

Referring to FIG. 6, first, the grid-shaped black matrixes 122 are formed on the insulating substrate 121 at operation S100, as shown in FIGS. 9a and 9b.

Then, a blue photosensitive liquid is coated on the insulating substrate 121 on which the black matrixes 122 are formed, by means of the slit coater 1, to form a blue photosensitive layer 126a at operation S200, as shown in FIGS. 9c and 9d. The slit nozzle 10 is supplied with the blue photosensitive liquid from the color photosensitive liquid tank 21a and coats the blue photosensitive layer 126a on the insulating substrate 121 while moving over the insulating substrate 121.

Next, the blue photosensitive layer 126a is patterned to form the blue color filter 123a, while the slit nozzle 10 is supplied with the cleanser at operation S300, as shown in FIG. 9e.

For example, the blue photosensitive layer 126a is pre-baked, exposed, developed, cleansed, and post-baked to form the blue color filter 123a. The pre-baking may be carried out by a hot plate for about 2 to about 4 minutes, and the post-baking may be carried out for about 20 to about 60 minutes at about 200 to about 230° C.

With the patterning process of the blue color filter 126a, the slit nozzle 10 is supplied with the cleanser from the cleanser supplier 30 and cleanses the cavity 14 and the nozzle part 15. The cleanser comprises the first or second cleanser according to the exemplary embodiments of the present invention.

When the blue photosensitive liquid remains in the slit nozzle 10, the nozzle part 15 is clogged as the solvent of the blue photosensitive liquid evaporates within the slit nozzle 10, or particles may be generated. The cleanser pushes the blue photosensitive liquid out of the slit nozzle 10 to cleanse the slit nozzle 10, thereby preventing the nozzle part 15 from being clogged and particles from being generated. Also, the cleanser efficiently removes the blue photosensitive liquid to prevent green photosensitive liquid to be supplied subsequently from being mixed with the blue photosensitive liquid.

Next, a green photosensitive layer 126b is formed on the blue color filter 123a at operation S400, as shown in FIG. 9f. In this course, the slit nozzle 10 is supplied with the green photosensitive liquid from the color photosensitive liquid tank 21b and coats the green photosensitive layer 126b on the insulating substrate 121 while moving over the insulating substrate 121.

The cleanser according to the exemplary embodiments of the present invention is effective in removing the photosensitive liquid, thereby reducing the possibility of mixing different photosensitive liquids when replacing a photosensitive liquid with a new one.

Thereafter, the green photosensitive layer 126b is patterned to form the green color filter 123b. The same processes are true of the red color filter 123c to complete the color filter 123, as shown in FIG. 9g.

Next, the overcoat layer 124 and the transparent electrode layer 125 are formed on the color filter 123 to complete the color filter substrate 120.

Then, the thin film transistor substrate 110 is adhered to the color filter substrate 120. Finally, the LCD device 100 is completed by injecting the liquid crystal layer 130 between the thin film transistor substrate 110 and the color filter substrate 120, shown in FIG. 7.

The usage of the cleanser according to the exemplary embodiments of the present invention is not limited to manufacturing the color filter. Alternatively, the cleanser may be applicable while exchanging one of two photosensitive liquids with the other in the slit coater. Also, the cleanser may be used in cleansing and managing the slit coater which employs a single photosensitive liquid.

As apparent from the above description, the exemplary embodiments of the present invention provide a cleanser for a slit coater which efficiently cleanses a slit coater.

Also, the exemplary embodiments of the present invention provide a slit coater with efficient cleansing capability for manufacturing a display device, and a manufacturing method of the display device using the slit coater.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A cleanser for a slit coater, comprising propylene glycol mono-methyl ether in an amount of about 70 to about 90 wt %, propylene glycol mono-methyl ether acetate in an amount of about 5 to about 20 wt %, and ethyl(3-ethoxy) propionate in an amount of about 5 to about 20 wt %.

2. The cleanser according to claim 1, wherein the amount of propylene glycol mono-methyl ether is about 75 to about 85 wt %, the amount of propylene glycol mono-methyl ether acetate is about 7 to about 13 wt %, and the amount of ethyl(3-ethoxy) propionate is about 7 to about 13 wt %.

3. The cleanser according to claim 2, further comprising acetone in an amount of about 5 to about 10 wt %.

4. A cleanser for a slit coater, comprising propylene glycol mono-methyl ether acetate in an amount of about 80 to about 9wt % and acetone in an amount of about 3 to about 20 wt %.

5. The cleanser according to claim 4, wherein the amount of propylene glycol mono-methyl ether acetate is about 90 to about 95 wt %, and the amount of acetone is about 5 to about 10 wt %.

6. The cleanser according to claim 4, further comprising propylene glycol mono-methyl ether in an amount of about 5 to about 13 wt %.

7. The cleanser according to claim 4, further comprising ethyl(3-ethoxy)propionate in an amount of about 5 to about 15 wt %.

8. A slit coater for manufacturing a display device, comprising:
a slit nozzle;
a color photosensitive liquid supplier which supplies at least two color photosensitive liquids of different colors to the slit nozzle; and
a cleanser supplier which supplies the slit nozzle with a cleanser for a slit coater, the cleanser comprising propylene glycol mono-methyl ether in an amount of about 70 to about 90 wt %, propylene glycol mono-methyl ether acetate in an amount of about 5 to about 20 wt %, and ethyl (3-ethoxy) propionate in an amount of about 5 to about 20 wt %.

9. The slit coater according to claim 8, wherein the amount of propylene glycol mono-methyl ether is about 75 to about 85 wt %, the amount of propylene mono-methyl ether acetate is about 7 to about 13 wt %, and the amount of ethyl(3-ethoxy)propionate is about 7 to about 13 wt %.

10. The slit coater according to claim 8, wherein the cleanser for the slit coater further comprises acetone in an amount of about 5 to about 10 wt %.

11. A slit coater for manufacturing a display device, comprising:
a slit nozzle;
a color photosensitive liquid supplier which supplies at least two color photosensitive liquids of different colors to the slit nozzle; and
a cleanser supplier which supplies the slit nozzle with a cleanser for a slit coater, the cleanser comprising propylene glycol mono-methyl ether acetate in an amount of about 80 to about 97 wt %, and acetone in an amount of about 3 to about 20 wt %.

12. The slit coater according to claim 11, wherein the amount of propylene glycol mono-methyl ether acetate is about 90 to about 95 wt %, and the amount of acetone is about 5 to about 10 wt %.

13. The slit coater according to claim 11, wherein the cleanser for the slit coater further comprises propylene glycol mono-methyl ether in an amount of about 5 to about 15 wt %.

14. The slit coater according to claim 11, wherein the cleanser for the slit coater further comprises ethyl(3-ethoxy)propionate in an amount of about 5 to about 15 wt %.

15. A method of manufacturing a display device, comprising:
forming a first color photosensitive layer by coating a substrate with a first color photosensitive liquid through a slit nozzle;
forming a first sub color filter by patterning the first color photosensitive layer, and cleansing the slit nozzle by supplying a slit coater cleanser to the slit nozzle, the cleanser comprising propylene glycol mono-methyl ether in an amount of about 70 to about 90 wt %, propylene glycol mono-methyl ether acetate in an amount of about 5 to about 20 wt %, and ethyl(3-ethoxy)propionate in an amount of about 5 to about 20 wt %; and
forming a second color photosensitive layer by coating the first sub color filter with a second color photosensitive liquid through the slit nozzle.

16. The method according to claim 15, wherein the amount of propylene glycol mono-methyl ether is about 75 to about 85 wt %, the amount of propylene glycol mono-methyl ether acetate is about 7 to about 13 wt % and the amount of ethyl(3-ethoxy)propionate is about 7 to about 13 wt %.

17. The method according to claim 15, wherein the cleanser for the slit coater further comprises acetone in an amount of about 5 to about 10 wt %.

18. A method of manufacturing a display device, comprising:
forming a first color photosensitive layer by coating a substrate with first color photosensitive liquid through a slit nozzle;
forming a first sub color filter by patterning the first color photosensitive layer, and cleansing the slit nozzle by supplying a slit coater cleanser to the slit nozzle, the cleanser comprising propylene glycol mono-methyl ether acetate in an amount of about 80 to about 97 wt % and acetone in an amount of about 3 to about 20 wt %; and
forming a second color photosensitive layer by coating the first sub color filter with a second color photosensitive liquid through the slit nozzle.

19. The method according to claim 18, wherein the amount of propylene glycol mono-methyl ether acetate is about 90 to about 95 wt % and the amount of acetone is about 5 to about 10 wt %.

20. The method according to claim 18, wherein the cleanser for the slit coater further comprises propylene glycol mono-methyl ether in an amount of about 5 to about 15 wt %.

21. The method according to claim 18, wherein the cleanser for the slit coater further comprises ethyl(3-ethoxy)propionate in an amount of about 5 to about 15 wt %.
